(19) United States
(12) Patent Application Publication
(10) Pub. No.: US 2014/0038303 A1
(43) Pub. Date: Feb. 6, 2014

(54) TEST KIT AND METHOD FOR DETECTION OF ADDITIVES IN FUEL COMPOSITIONS

(71) Applicants: Keith Reading, Pool Lane (GB); Elaine McFarlane, Pool Lane (GB)

(72) Inventors: Keith Reading, Pool Lane (GB); Elaine McFarlane, Pool Lane (GB)

(21) Appl. No.: 13/980,935

(22) PCT Filed: Jan. 23, 2012
(86) PCT No.: PCT/EP12/50977

§ 371 Date: Aug. 13, 2013

(30) Foreign Application Priority Data
Jan. 21, 2011 (EP) 11151722.3

(51) Int. Cl. G01N 31/22

(52) U.S. Cl. CPC G01N 31/22
USPC 436/141; 422/430; 29/428

(57) ABSTRACT

Method for detecting a basic target species in a fuel composition, involving (i) contacting the composition with a solid (for example paper) substrate carrying a spectroscopically active indicator which is capable of reacting with the target species, and (ii) detecting the spectroscopic response of the indicator on or following its contact with the fuel composition. The target species may be a detergent or dispersant additive or a constituent thereof, for example in an automotive fuel. The spectroscopic response may be a colour change, and the indicator may for example be a phenolphthalein indicator such as tetrabromophenolphthalein ethyl ester (HTBPE). Also provided is a test kit for use in the invented method, which may comprise a reference, such as a colour chart, with which to compare the spectroscopic response of the indicator. The indicator-carrying substrate is suitably packaged in a protective atmosphere.

### TECHNICAL FIELD OF THE INVENTION

This invention relates to a method and kit for detecting a target species in a fuel composition.

### BACKGROUND TO THE INVENTION

It is known to include additives in fuel compositions, in particular automotive fuel compositions, for various purposes. Such additives include for example lubricity enhancers, static dissipaters, cold flow additives, ignition improvers and corrosion inhibitors. In particular it is common to include a detergent additive in a fuel composition, in order to reduce the level of deposits in an engine or other fuel-consuming system running on the fuel. Higher levels of such detergent additives are sometimes included in so-called “premium” fuels.

It can often be desirable, for instance for quality control purposes, to verify the presence of a particular additive in a fuel composition, and/or to determine its concentration. However there are currently few straightforward tests available, for use in either the laboratory or in particular in the field, for determining the presence and/or concentration of a detergent additive in a fuel. Some fuel analysis methods can suffer from drawbacks such as inapplicability to diesel, as opposed to gasoline, fuels; a requirement for complex or time-consuming analytical equipment or techniques; and/or calibration or standardisation issues, such as where the results vary according to the nature of the fuel being tested.

At present, if the additive content of a fuel needs to be determined, a sample often has to be subjected to relatively complex, time-consuming and/or expensive chemical analyses, which may involve shipping it to an external laboratory. Determining the concentration of a typical amine-based detergent additive, for example, could involve chemical analysis of the nitrogen content of the fuel—such a technique would however be limited since typical detergent additive levels result in nitrogen concentrations of about 1 to 10 ppm whereas many routine analytical laboratories are only able to quantify nitrogen levels to a limit of 5 ppm.

US-A-2008/0190354 discloses a method and kit which can be used to detect a basic species, such as a detergent additive, in a fuel composition. The method involves detecting a spectroscopic response (for example a colour change) in an indicator which is added to the fuel. It is said to be usable by relatively unskilled operators in the field, without the need to ship fuel samples to an external laboratory. However, the method and kit described in US-A-2008/0190354 require the indicator to be carried in a suitable solvent, for example in glass ampoules. The preparation, storage, transportation and manipulation of fluid reagents can add significantly to the cost and complexity of a detection system. The handling of fluid reagents can also present greater health and safety risks, as can the disposal of the empty glass ampoules. Moreover some spectroscopically active indicators, such as the HTBPE used in US-A-2008/0190354, can be unstable in solution, which can create problems during the storage and distribution of the detection kits.

It is an aim of the present invention to provide an alternative way of detecting additives in fuel compositions, embodiments of which can overcome or at least mitigate the above described problems.

### SUMMARY OF THE INVENTION

According to a first aspect of the present invention there is provided a method for detecting a basic target species in a fuel composition, the method involving (i) contacting the composition with a solid substrate carrying a spectroscopically active indicator which is capable of reacting with the target species, and (ii) detecting the spectroscopic response of the indicator on or following its contact with the fuel composition.

Because the indicator is carried on a solid substrate, the method of the invention does not require the storage, transportation or handling of fluid reagents such as indicator solutions. This can make it cheaper to produce, store and distribute the components needed to carry out the method. The indicator-carrying substrate, suitably packaged as described below, can be transported relatively easily for example on a road vehicle, train, boat or aeroplane, even to remote locations.

The method is also relatively easy to use, requiring no specialist laboratory expertise or chemical handling procedures and thus having a relatively low risk profile.

The substrate can, for example, simply be dipped into the fuel composition under test, rather as one would dip a strip of litmus paper into a sample in order to determine its pH. Thus the invented method can be used by relatively unskilled operators, including non-technical operators such as product managers or sales teams. It can also be used in the field, wherever a fuel composition needs to be tested.

Moreover, carrying the indicator on a solid substrate rather than in solution can help to overcome indicator stability issues during storage and handling, in that an immobilised indicator can be more readily protected from environmental influences such as light, oxygen and moisture, for instance by packaging the solid substrate in a protective environment.

An indicator which undergoes a visible response, such as a dye, may also be easier to interpret when carried on a solid substrate than when present in solution. For example, the phenolphthalein dye used in US-A-2008/0190354 can undergo a degree of fluorescence, making it necessary, ideally, to assess colour changes against a constant light source. Such effects can be mitigated by immobilising the dye on a solid substrate such as a paper sheet.

Although it is known to apply a pH indicator such as litmus dye to a paper substrate, for use in simple laboratory tests on aqueous solutions, there is no precedent for using a paper-based test in the analysis of fuels or fuel additives. The present invention thus represents a step away from conventional fuel additive detection systems, in which analytical reagents are utilised in liquid form.

### DETAILED DESCRIPTION

The method of the invention may be for detecting the presence or absence of the target species in the fuel composition, and/or for detecting information about the concentration of the target species in the composition. In the latter case, the method may provide an approximate indication of the target species concentration (for example, indicating one or more ranges within which the target species concentration falls) and/or a more precise indication.

The term “fuel composition”, in the context of the present invention, embraces a sample taken from a fuel composition, for instance for the purpose of carrying out the method of the invention and/or another analytical test.

A basic target species is a species which acts as a base, which term includes a Lewis and/or Lowry-Brønsted base. It may be monomeric, oligomeric or polymeric, and will typically be organic. It may contain one or more nitrogen-containing basic groups selected for instance from amines, imines, imides and succinimides. It may for instance contain one or more primary, secondary or tertiary amine groups, which may be selected from tertiary and secondary amine groups, in particular tertiary.

In an embodiment of the invention, the basic target species may be or contain a species selected from succinimides (for example alkenyl succinimides or bis-succinimides), polybuteneamines, polyetheramines, amino-triazoles, quaternary ammonium salts (including of succinimides), Mannich and bis-Mannich reaction products, substituted aminoalkanes (for example diaminopropanes), polyesteramines, salts of polyolefins with pyridinium salts, polyamines, long chain aliphatic amines, and mixtures thereof.

In an embodiment of the invention, the basic target species may be or contain a species selected from alkenyl succinimides, polybuteneamines, polyetheramines, bis-succinimides and mixtures thereof.

The target species may be any fuel component or additive which is present, or could be present (in particular, which is likely and/or suspected to be present) in the fuel composition. In an embodiment, the target species is a fuel additive or constituent thereof—examples of additives which can contain basic species include detergents (which may contain organic amines, imides and/or succinimides such as those referred to above), stabilisers and antioxidants (which may include polyamines such as phenylenediamine), dispersants (which may contain polyamines and/or succinimides) and metal deactivators (which may contain diamines such as N,N′-disalicylidene-1,2-propanediamine). In an embodiment the target species is a detergent or dispersant additive or constituent thereof.

A detergent of the type used in a fuel additive is an agent (suitably a surfactant) which can act to remove, and/or to reduce the build-up of, combustion related deposits within a fuel combustion system, in particular in the fuel injection system of an engine such as in the injector nozzles. A dispersant is an agent which acts to keep solids suspended in a fuel, and hence to reduce their deposition on engine surfaces. The active ingredients of detergent and dispersant additives are typically basic in character and hence are suitable for detection using the method of the present invention.

Examples of known detergents include polyolefin substituted succinimides and succinamides of polyamines, for instance polyisobutylene succinimides or polyisobutylene amine succinamides; aliphatic amines (for example long chain aliphatic amines, and/or those having at least one terminal secondary or tertiary amine, as described in US-2007/0214713); Mannich bases; reaction products of amines and polyolefin (eg polyisobutylene) maleic anhydrides; amino-triazoles (for example as described in US-A-2009/0282731); ammonium salts such as can be formed by the reaction of a carboxylic acid with di-n-butylamine or tri-n-butylamine (for example as described in EP-A-1 900 795), or by the reaction of a hydrocarbyl-substituted acylating agent with a tertiary amine and a quaternizing agent (as described in WO-A-2009/040582 and US-A-2010/0257779), including quaternary ammonium salts of succinimides and a range of other quaternary ammonium salts; bis-Mannich reaction products such as can be formed from a reaction between an aldehyde, a polyamine and an optionally substituted phenol (for example as described in WO-A-2009/040582); other reaction products of carboxylic acid-derived acylating agents and amines (again as described for example in WO-A-2009/040582); salts of polyolefins with pyridinium salts; reaction products of succinic anhydrides with amine-containing polyalkylene polymers (for example as described in US-A-2007/0245621); alkoxylates of phenolic (especially naphthol) resins (for example as described in US-A-2008/0028672); and reaction products of hydrocarbyl-substituted succinic acids or anhydrides with hydrazine (as described for example in EP-A-1 887 074).

Succinimide dispersant additives are described for example in GB-960,493, EP-A-147 240, EP-A-482 253, EP-A-613 938, EP-A-557 561 and WO-A-98/42808. Detergent-containing fuel additives are known and commercially available for instance from Infineum™ (eg F7661 and F7685), Innospec™ (eg OMA 4130D) and Lubrizol™ (eg the Lz8043 series).

Where the invention is used to detect such an additive in a fuel composition, the additivated fuel composition suitably contains at least 10 mg/kg of the basic target species, such as at least 20 or 40 mg/kg. It may for example contain from 10 to 2000 mg/kg of the basic target species, or from 20 to 1000 or from 40 to 500 mg/kg. The method of the invention may however be used to detect the absence of the additive, in which case the fuel composition may contain lower concentrations of the target species, or indeed none at all.

A “spectroscopically active” indicator is any material (either an individual substance or a mixture of two or more substances) which is capable of undergoing a change in its electromagnetic absorption, reflectance, transmission and/or emission spectrum when contacted with a fuel composition containing the basic target species—this change is the “spectroscopic response” of the indicator to being contacted with the fuel composition. Thus a spectroscopic response is a change in the ability of the indicator to absorb, reflect, transmit and/or emit electromagnetic radiation, at any one or more wavelengths.

In the method of the invention, the spectroscopic response of the indicator may be or involve a change in the degree to which (ie the intensity with which) the indicator absorbs, reflects, transmits and/or emits electromagnetic radiation, and/or in one or more of the wavelengths at which it absorbs, reflects, transmits and/or emits electromagnetic radiation. In an embodiment the response is a visible response, such as a colour change.

The indicator should thus be capable of signaling, spectroscopically and suitably visually, information about the basic target species in a fuel composition with which it comes into contact. Such information may be qualitative and/or quantitative. In an embodiment, the signal occurs only if the target species is present, or is present at a concentration above a particular minimum; if the target is not present, or is present at below the minimum concentration, it may then be the absence of the signal which conveys the desired information. Thus, the spectroscopic “response” of the indicator, on or following its contact with the fuel composition, may be an absence of change in its electromagnetic absorption, reflectance, transmission and/or emission spectrum.

In an embodiment of the invention, the indicator is active in (ie capable of undergoing a change in) the visible and/or ultraviolet (UV) ranges of the electromagnetic spectrum. In an embodiment, it is active in the visible range.

Thus a spectroscopic response may be or involve a visible response, by which is meant a response which takes place in the visible region of the electromagnetic spectrum and is suitably detectable by the human eye. In other words, a visible response involves a change in the ability of the indicator to absorb, reflect, transmit and/or emit electromagnetic radiation in that part of the electromagnetic spectrum between the infrared and ultraviolet regions (referred to in this specification as “visible light”). In an embodiment, the response is or involves a change in the colour of the indicator. This will usually be due to the reaction of the indicator with the basic target species.

The indicator may be capable of generating two or more spectroscopically distinct responses, for example two or more distinct colours, dependent on the nature and/or concentration of the target species in the composition. In an embodiment, the intensity and/or amplitude of the response may depend on the concentration of the target species in the composition. Thus the method of the invention may be capable of yielding two or more different results, each involving a different spectroscopic response from the indicator.

The indicator must be capable of reacting with the target species, the term “reacting” embracing the formation of covalent, ionic, dative and hydrogen bonds, associations as through complexing, and combinations thereof. In an embodiment, the indicator is capable of forming a charge transfer complex with the target species. Such a complex may involve a chemical bond such as a hydrogen bond, a dative bond, a covalent bond or an ionic bond such as would occur on the formation of a dissociated ion pair between the two species (eg on donation of a proton by the indicator to a functional group present on the target species).

The reaction may involve a looser association between molecules and/or ions of the indicator and target species, so long as the thus-formed reaction product is capable of generating a detectable spectroscopic response (for example, it may be coloured, and/or have a different colour to that of the indicator alone).

In an embodiment of the invention, a charge transfer complex is formed between the indicator and an amine or imine group on the target species.

The indicator is thus suitably an acid, which term includes a Lewis and/or Lowry-Brønsted acid. It is suitably capable of donating a proton to, and/or of hydrogen bonding with, a base (such as an amine) so as to form a charge transfer complex and thus to produce a spectroscopic response. In an embodiment the indicator is capable of forming a coloured charge transfer complex with a base.

The indicator may thus be an acid/base indicator, which produces a spectroscopic response (such as a colour change) in response to a change in pH. The spectroscopic response may take place at a precise pH value.

Suitable acid/base indicators, capable of producing a colour change in response to the presence of a basic species such as an amine, include for example Bromophenol Blue, Bromocresol Green, Methyl Orange, Neutral Red and Nile Blue. Such indicators can exist in two distinctly different coloured chemical forms at different pHs, the transition from one to the other typically occurring rapidly and at a clearly defined pH.

Examples of commercially available acid/base indicators include those sold under the trade marks UNIMARK (United Color Manufacturing, USA), MORTRACE MP (Orgachim/Rohm & Haas) and DYEGUARD MARKER MP (John Hogg Technical Solutions).

In an embodiment of the invention, the indicator has a colour, on reaction with the basic target species, which is in the blue end of the visible spectrum, ie which suitably has a wavelength shorter than about 550 nm, or shorter than about 530 or 500 or 480 nm. Such colours tend to be more readily detected and distinguished, in particular in diesel fuel compositions (which are typically yellow or brown in colour), than colours such as red, orange, yellow or even green.

In an embodiment, the indicator produces a distinct change in colour, rather than a mere change in intensity of colour, in response to the presence of the basic target species.

The indicator may be a phenolphthalein indicator, in particular tetrabromophenolphthalein or a derivative thereof such as a tetrabromophenolphthalein ester. It may be a tetrabromophenolphthalein alkyl ester such as tetrabromophenolphthalein ethyl ester (HTBPE) or a salt, in particular a metal salt, thereof such as potassium tetrabromophenolphthalein ethyl ester (KTBPE). HTBPE may be particularly suitable for use in the present invention, as it produces a distinct colour change from amber to blue on reaction with basic species such as amines, this being readily detectable even in coloured diesel fuels and even in the presence of additional basic species which may be included, albeit at lower concentrations than the target species, in a fuel composition. HTBPE may for example be obtained from Acros Organics (www.acros.com), or from Sigma Aldrich (www.sigmaaldrich.com).

The use of HTBPE to detect primary, secondary and tertiary alkylamines in a sample has been disclosed by Sakai et al in Analytical Chemistry, 69(9), 1766-1770. The authors observed the formation of reddish amine-HTBPE charge transfer complexes, the absorption maxima for which occurred at slightly different wavelengths dependent on the degree of substitution of the amine. They also observed the formation of blue charge transfer complexes when the ordinarily yellow HTBPE was added to 1,8-bis(N,N-dimethylamine)naphthalene, a highly basic amine which was believed to have reacted with the indicator to form a quaternary ammonium cation and TBPE anion pair.

HTBPE was also disclosed, in US-A-2008/0190354, as an indicator for detecting basic species such as detergent additives in fuel compositions. However, as discussed above, it was used in the form of a solution in a hydrocarbon solvent, rather than immobilised on a substrate as in the method of the present invention.

In the method of the invention, the substrate which carries the indicator may be a flexible substrate. In an embodiment, it is an absorbent substrate. It may for example be a paper, card, textile or plastics substrate. In an embodiment, it is a paper substrate, for example of filter or chromatography grade. In another embodiment, it is a chromatography grade filter paper. In an embodiment, the paper does not carry a varnish or other gloss-type coating, at least in the region which carries the indicator: coated inkjet papers, for example, may be less preferred in certain embodiments of the invention.

The substrate should have sufficient strength to retain its structure during use in a fuel test, for example during immersion for between 1 and 5 seconds in a fuel composition. It may, in particular if made of paper, have a thickness of 0.2 mm or greater, or of 0.3 mm or greater, for example from 0.3 to 0.5 mm or from 0.3 to 0.4 mm, such as about 0.35 mm.

In an embodiment, the indicator is coated onto at least part of the substrate surface. The coating may be achieved in conventional manner, for instance by dipping the substrate in, or spraying or brushing it with, a solution of the indicator in an appropriate solvent. In an embodiment of the invention, the substrate is dipped into the indicator solution, as this can help to achieve better coverage.

In an embodiment, at least part of the substrate is impregnated with the indicator. Again this may be achieved in conventional manner, for instance by immersing the substrate in a solution of the indicator.

The indicator is suitably applied to the substrate in an inert atmosphere, for instance under argon gas, to avoid problems due to the potential instability of the indicator solution.

The substrate suitably carries sufficient indicator for a user to be able to detect the spectroscopic response of the indicator on contacting it with a fuel composition. Suitably the user is able to detect the spectroscopic response using the naked eye. Thus, for example, where the indicator is a dye and its spectroscopic response a colour change, the substrate suitably carries sufficient indicator for the user to be able to judge, by eye, the colour of the indicator after contacting it with the fuel composition under test. It suitably carries sufficient indicator for the user to be able to differentiate, by eye, between two or more colours which the indicator is capable of exhibiting, for example in response to being contacted with different types of fuel composition or with fuel compositions containing significantly different concentrations of the basic target species. The substrate may carry indicator at a level insufficient to appreciably change the colour of the solid substrate, until the substrate is contacted with a fuel composition.

In order to apply the indicator to the substrate, for instance by coating or impregnation, the indicator may first be dissolved in a suitable solvent. Such a solvent is suitably inert, and suitably does not interfere with the spectroscopic response of the indicator on contact with the fuel composition. Suitable such solvents include toluene; alcohols (in particular C₁ to C₈ or C₂ to C₆ alcohols) such as isopropanol; DCE and mixtures thereof. The concentration of the dye in the solution may be 0.025% w/w or greater, or 0.05 or 0.075% w/w or greater; it may be up to 0.2% w/w, or up to 0.15% w/w: where the dye is HTBPE, a suitable concentration range might for instance be from 0.05 to 0.2% w/w, such as about 0.1% w/w.

Following application of the indicator solution, the substrate may then be dried so as to remove all or substantially all of the solvent.

In an embodiment of the invention, the substrate carries, or is otherwise associated with, means for protecting the indicator from one or more external influences. The external influences may for example be selected from air (or at least oxygen), water, light and combinations thereof. This can help to overcome any problems due to indicator stability.

Preferred said means for protecting the indicator comprises a desiccant material which may suitably be any conventional desiccant, most suitably a molecular sieve desiccant, such as a zeolite desiccant, or silica gel. Said means can be incorporated into the packaging of, or for, the indicator-carrying substrate, for example incorporated into a container or packaging holding or carrying said substrate.

In one specific embodiment, the indicator-carrying substrate is packaged in a protective atmosphere. It may for instance be packaged within a sealed chamber formed from a fluid-impermeable material such as a metal and/or plastics foil: an example of such a package might be a sealed envelope or a so-called “blister pack”. The impermeable packaging material is suitably impermeable to air (or at least oxygen), water and/or light, ideally all three. In an embodiment, the chamber contains an inert or at least oxygen-free fluid, in particular a gas, such as nitrogen or argon. The fluid in the chamber is suitably dry, or substantially so. The chamber may contain a desiccant material.

In another specific embodiment, the indicator carried on the substrate is encapsulated, for example microencapsulated, within suitable encapsulating entities which are capable of shielding it from one or more external influences. The encapsulating entities should be capable of releasing the indicator at an appropriate point prior to, or on, use, for example on contact with the fuel composition or another reagent, or on application of a physical force such as abrasion.

In yet another specific embodiment, the indicator is carried on the substrate beneath a layer of a protective material, such as a plastics film: this may for example be a tear-off film which can be removed from the substrate immediately prior to use in the invented method.

According to the invention, the substrate carrying the indicator may be contacted with the fuel composition (or with a sample thereof) in any suitable manner. For example, a sample of the fuel composition may be applied as drops onto the substrate, for instance using a pipette. In an alternative embodiment, the substrate (or at least a dye-carrying portion of the substrate) may be dipped into, or immersed in, the fuel composition for an appropriate period of time. This latter embodiment, which is similar to dipping a litmus paper into a sample in order to determine its pH, is relatively easy to carry out and is thus suitable for use by unskilled operators in the field. The substrate or portion may be dipped into, or immersed in, the fuel composition for between 0.5 and 5 seconds, suitably for between 1 and 3 seconds.

The spectroscopic response of the indicator may be detected by any suitable means, for instance spectroscopy (ie by investigating the electromagnetic absorption, reflectance, transmission and/or emission spectrum for the indicator at one or more wavelengths). In an embodiment of the invention, the response is detected by the naked eye. Suitably, its detection involves assessing the colour of the indicator on or after, and optionally also before, its contact with the fuel composition.

In general, references to “detecting” a spectroscopic response mean detecting the presence, the absence, the nature and/or the magnitude of such a response.

An indicator developing process may be required in order to detect the spectroscopic response. An indicator developing process is a process which induces a spectroscopic response in a spectroscopically active indicator, or in a reaction product formed between the indicator and a basic target species, including if there was no (or no detectable) previous spectroscopic response in the indicator or reaction product. A developing process thus allows detection of an indicator, or of an indicator reaction product, where it may not previously have been detectable for instance by spectroscopic means or by the naked eye. Such a developing process may be of known type. It may involve for instance altering a condition of the indicator or reaction product, such as its temperature. It may involve the addition of one or more reagents capable of inducing a chemical change in the indicator or reaction product. It may involve irradiation of the indicator or reaction product, for instance with UV radiation and/or to cause the indicator or product to fluoresce. The developing process may elicit in the indicator or reaction product a spectroscopic response which was not present prior to the developing process.

In an embodiment of the invention, however, the spectroscopic response of the indicator is capable of detection without such a developing process.

The method of the invention may additionally involve comparing the detected spectroscopic response with one or more spectroscopic responses produced by contacting the indicator with one or more reference fuel compositions, for instance compositions containing known concentrations (or concentrations within known ranges) of the target species. The detected response may be compared directly with a response from a reference composition, or indirectly for example using a spectrum, colour chart or other (suitably graphic) representation of a response from a reference composition. Use of a colour chart or similar representation may make the method particularly suitable for use in a field test, for the relatively rapid and straightforward in situ testing of a fuel composition.

Comparison of the detected response with a reference response in this way can facilitate interpretation of the test result, helping a user to determine whether or not the fuel composition contains the target species and/or information about the concentration of the target species in the composition.

The present invention thus makes use of a relatively simple and inexpensive test procedure, capable of generating an immediately detectable and interpretable result. Such a test has the advantage that it can be performed by a relatively unskilled operator, and can be used, if necessary, in the field. It can allow the immediate detection of a target species, and in cases also at least an estimate of the concentration of that species in the fuel composition under test. Thus it may be used, for example, to distinguish between a fuel composition containing an additive at its standard treat rate and a so-called “premium” fuel composition containing a higher treat rate of the additive.

Embodiments of the invention can moreover generate a result without the need to “develop” the indicator in any way for instance by the addition of further reagents. The invention can be carried out without the need for additional equipment such as sample vessels, and requires contacting only one component (the indicator-carrying substrate) with the fuel composition under test.

A method according to the invention may for example be used for quality control or assurance purposes, for market research, for testing compliance with regulatory requirements or other relevant specifications, for detecting counterfeit products or for tracking the distribution or use of a fuel composition.

It may be used to signal to a user a property of a fuel composition, for example the presence and/or the quantity of a target basic species, in particular a detergent additive or constituent thereof, in the composition. In this context a “user” includes any person or body involved in the supply, transportation, storage, testing or use of the composition or the handling of the composition for any other purpose.

A method according to the invention may be used as part of a method for increasing customer loyalty or brand awareness and in turn market share, or of a method for reassuring customers or other users of quality standards, or of a method for detecting counterfeit or illegally traded products, or of a method for quality control of fuel compositions, or of a method for managing the distribution of fuel compositions to users, or of a method for monitoring the areas of use, storage and/or disposal of fuel compositions.

The method of the invention is suitably carried out at a temperature from about 18 to 30° C., or from about 18 to 25° C. or 20 to 25° C. or at about 20° C.±2° C. It is suitably carried out at or around atmospheric pressure. Thus, the method may be carried out under ambient conditions, again making it suitable for use as a field test.

The method may be carried out in the presence of a suitable inert solvent, for example a hydrocarbon solvent such as toluene or an alkane (eg a C₅ to C₁₂ or C₅ to C₈ alkane, in particular n-heptane or n-hexane), or a mixture of two or more such solvents. The solvent may be added to the fuel composition before contacting it with the indicator-carrying substrate. In an embodiment, however, the fuel composition may be contacted directly with the indicator-carrying substrate, without the need to dilute it first.

A method according to the invention may be used to detect a basic target species in any type of fuel composition, for example an automotive fuel composition. The fuel composition may for example be an automotive gasoline composition, of the type which is suitable and/or adapted and/or intended for use in a spark ignition (petrol) internal combustion engine, or an automotive diesel composition of the type which is suitable and/or adapted and/or intended for use in a compression ignition (diesel) internal combustion engine.

In general the fuel composition may be selected from naphtha, kerosene, gasoline and diesel fuel compositions, in particular gasoline and diesel fuel compositions. It may be a middle distillate fuel composition, for example a heating oil, a lubricating oil (either industrial or automotive), an industrial gas oil, an on- or off-road automotive diesel fuel, a railroad diesel fuel, a marine fuel, a diesel fuel for use in mining applications or a kerosene fuel such as an aviation fuel or heating kerosene. In an embodiment the fuel composition is for use in an engine such as an automotive engine or an aircraft engine. In an embodiment it is for use in an internal combustion engine. In an embodiment it is an automotive fuel composition. In a specific embodiment, it is an automotive diesel fuel composition, such as an automotive gas oil (AGO).

It may be preferred for the fuel composition not to contain, or to contain only low levels of (for example 100 mg/kg or less of), fuel additives containing acidic species (for example fatty acids, which may be present in corrosion inhibitors and lubricity additives). It may be preferred for the fuel composition not to contain, or to contain only low levels of (for example 100 mg/kg or less of), fuel additives containing basic species (in particular amines) other than the target basic species—examples of such additives include stabilisers, antioxidants and metal deactivators.

In an embodiment of the invention, the fuel composition is, prior to its contact with the indicator, colourless or substantially so, by which is meant that it is capable of transmitting all or substantially all visible light incident on it. Detection and interpretation of spectroscopic responses—in particular colour changes—may be easier when using such fuels than when using fuels which are themselves coloured. The fuel composition may however be coloured, for instance yellow or brown as are many petroleum derived diesel base fuels.

In an embodiment the fuel composition contains a major proportion (by which is meant for example 80% v/v or greater, or 90 or 95% v/v or greater, or 98 or 99 or 99.5 or 99.8% v/v or greater) of, or consists essentially or entirely of, a base fuel such as a distillate hydrocarbon base fuel, optionally (although subject to the comments above) together with one or more additional components such as fuel additives.

A base fuel may be for example a naphtha, kerosene or diesel fuel. A naphtha base fuel will typically boil in the range from 25 to 175° C. A kerosene base fuel will typically boil in the range from 150 to 275° C. A diesel base fuel will typically boil in the range from 150 to 400° C., or from 150 or 180 to 360 or 370° C. Fuel distillation properties may be measured using a standard test method such as ASTM D86 or EN ISO 3405.

In an embodiment the base fuel is a middle distillate base fuel, in particular a diesel base fuel which is suitable for combustion within a compression ignition (preferably diesel) engine. In this case the base fuel may itself comprise a mixture of middle distillate fuel components (components typically produced by distillation or vacuum distillation of crude oil), or of fuel components which together form a middle distillate blend. It may be for example a gas oil. It may be petroleum derived. Alternatively it may be synthetic: for instance it may be the direct or indirect product of a Fischer-Tropsch condensation. It may be or include a biofuel component, which has been derived—whether directly or indirectly—from a biological source. It may be or include an oxygenate such as a vegetable oil or vegetable oil derivative (eg a fatty acid ester, in particular a fatty acid methyl ester (FAME)).

The method of the invention finds useful application where the fuel composition is a very low or zero sulphur containing composition. A zero sulphur composition is to be understood as containing less than a detectable amount of sulphur. A very low sulphur containing composition contains 500 ppmw or less of sulphur, suitably 350 ppmw or less, 150 ppmw or less, 100 ppmw or less or most suitably 10 ppmw or less. Such fuel compositions may be the result of hydrotreating, in a manner known to the skilled person, a normal sulphur containing refinery stream, or may be a synthetic fuel composition, or a blend of the two. Most suitably the very low or zero sulphur containing fuel composition is a diesel fuel composition.

In an embodiment of the invention, the fuel composition contains one or more Fischer-Tropsch derived fuel components. It may for example contain 1% v/v or greater, or 5% v/v or greater, or 10 or 15 or 20% v/v or greater, of a Fischer-Tropsch derived fuel component. The concentration of the Fischer-Tropsch derived fuel component may in cases be up to 100% or up to 99.99% v/v, such as up to 99.8 or 99.5 or 99 or 98% v/v, for example up to 80 or 70 or 75 or 50% v/v, or up to 40 or 30% v/v.

A Fischer-Tropsch derived fuel component is, or derives from, a synthesis product of a Fischer-Tropsch condensation process, for example the process known as Shell Middle Distillate Synthesis (van der Burgt et al, “The Shell Middle Distillate Synthesis Process”, paper delivered at the 5^{th} Synfuels Worldwide Symposium, Washington D.C., November 1985; see also the November 1989 publication of the same title from Shell International Petroleum Company Ltd, London, UK). It may also be referred to as a GtL (“Gas-to-Liquid”) fuel, or as an XtL fuel (where the gases which are converted into liquid fuel components using the Fischer-Tropsch process are themselves derived from non-gaseous sources such as coal, biomass or other hydrocarbons).

Fischer-Tropsch derived fuels tend to be colourless or substantially so, and may thus be less likely to affect any spectroscopic response produced by the indicator in the method of the invention. They also typically contain lower levels of basic species, as compared for instance to petroleum derived fuels, and may thus be less likely to affect the response produced by a base-sensitive indicator.

In a fuel composition to which the method of the invention is applied, the Fischer-Tropsch derived fuel component may be for example a Fischer-Tropsch derived naphtha, kerosene or gas oil, in particular a gas oil.

A second aspect of the present invention provides a test kit for use in detecting a basic target species in a fuel composition, the kit comprising a solid substrate carrying a spectroscopically active indicator which is capable of reacting with the target species. Such a kit may be used to carry out a method according to the first aspect of the invention.

In an embodiment, the kit also comprises a reference with which to compare the spectroscopic response of the indicator on or after being contacted with the fuel composition.

The solid substrate may carry, or be otherwise associated with, means for protecting the indicator from one or more external influences. The external influences may for example be selected from air (or at least oxygen), water, light and combinations thereof. In an embodiment, the substrate is packaged in a protective atmosphere, for instance as described above in connection with the first aspect of the invention. In an embodiment, it is packaged within a “blister-pack”. A kit according to the invention may include two or more separately packaged substrates, for use in testing more than one fuel composition.

Where the kit includes a reference, the reference may comprise a representation (for example a graphic representation) of one or more spectroscopic responses produced by contacting the indicator with one or more reference fuel compositions containing known concentrations (or concentrations within known ranges) of the target species. It may for example take the form of a colour chart; a printed spectrum such as an electromagnetic absorption, reflectance, transmission and/or emission spectrum; a calibration plot of absorption, reflectance, transmission and/or emission properties against target species concentration at one or more relevant wavelengths; or a data table.

In an embodiment, the reference comprises a colour chart, showing the colour(s) of the indicator on or after its contact with one or more suitable reference fuel compositions, for instance the colour(s) observed when the indicator is contacted with one or more fuel compositions containing known concentrations (or concentrations within known ranges) of the relevant target species.

The colour charts may include colours for two or more different fuel compositions, for example for fuel compositions having different initial colours; this can allow test results to be more readily interpreted, even for different coloured fuel compositions.

The colour charts may include colours for two or more different target species, allowing the test kit to be used to detect two or more potential constituents of a fuel composition.

It may be appropriate for a reference to show a range of indicator responses (for example a range of colours) which could be produced by contacting the indicator with a certain type or types of fuel composition, or with a certain type or types of target species, or with a certain concentration—or range of concentrations—of the target species.

A kit according to the second aspect of the invention may optionally also include one or more of the following:

(a) one or more sample vessels in which to collect samples of fuel compositions to be tested, and if appropriate in which to contact them with the indicator-carrying substrate;
(b) one or more applicator tools—for example pipettes, swabs or brushes—with which to apply a fuel composition to the substrate;
(c) one or more solvents—for example selected from n-heptane, n-hexane, toluene and mixtures thereof—with which to dilute a sample of a fuel composition;
(d) instructions for using the kit in order to detect the target species in a test fuel composition (such instructions may be written and/or recorded on another training medium such as a video, DVD, computer disk or other electronic file storage device);
(e) apparatus for use in detecting a spectroscopic response (for example a spectrophotometer) or to assist in its detection (for example a light box to aid reading of a colour chart or assessment of a coloured test sample, or a UV lamp to reduce the effects of dye fluorescence);
(f) means for developing the indicator, for example a UV lamp to “develop” a fluorescent indicator, or one or more developing reagents;
(g) one or more cleaning compositions, such as solvents or solvent mixtures, for use in cleaning a sample vessel or applicator tool prior to use;
(h) safety equipment selected for instance from disposable gloves, safety goggles, containers for disposing of tools and waste vessels in which to dispose of used fluids such as solvents or fuel samples.

In an embodiment, the kit includes one or more of components (a), (b), (c) and (d). In another embodiment, it includes one or more of components (a), (b) and (d). In a further embodiment, it includes one or more of components (b) and (d). In a yet further embodiment, it includes at least the component (d).

It may however be preferred for the kit to include simply the indicator-carrying substrate, optionally with a reference and optionally with instructions as described at (d) above and optionally with one or more applicator tools as described at (b) above. In other words, components (a), (c) and (e) to (h) may be absent from the kit, as may components (b) and/or (d) in some embodiments.

A test kit according to the invention may be suitable and/or adapted and/or intended for use either in a laboratory or in the field, preferably at least the latter. In the latter case, it may be preferred for the kit not to include apparatus for detecting a spectroscopic response, but for the operator to be required to detect the response by eye. Such a kit may however include apparatus, such as a light box, to assist in detection of a spectroscopic response.

In a kit which is suitable and/or adapted and/or intended for use in the field, the reference with which to compare the spectroscopic response suitably comprises one or more colour charts.

A third aspect of the invention provides a method for preparing a test kit according to the second aspect, or an essential component of such a test kit, the method involving loading a spectroscopically active indicator onto a solid substrate. The substrate may for example be coated with or impregnated with the indicator. The natures of the substrate and indicator, and the manner in which the indicator is loaded onto the substrate, may be as described above in connection with the first and second aspects of the invention.

Suitably, the indicator is loaded onto the solid substrate in an inert, or at least oxygen-free, atmosphere. The loading may for instance be carried out in an inert gas such as argon or nitrogen. It may be carried out in the dark, for example if the indicator is photosensitive, or at least in the absence of UV light. The inert or oxygen-free atmosphere is suitably dry.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, for example for the concentration of a fuel component, then a range of values defined by a combination of any of the upper limits with any of the lower limits may also be implied.

The following non-limiting examples illustrate the use of methods and kits in accordance with the invention.

### BRIEF DESCRIPTION OF THE DRAWINGS

FIG. 1 is a schematic perspective view of a test kit in accordance with the invention.

FIG. 2 is a schematic cross section through an indicator-carrying substrate, in a protective packaging, for use as part of a test kit according to the invention.

FIGS. 3 and 4 are schematic cross sections through indicator-carrying substrates for use in alternative test kits according to the invention.

### EXAMPLE 1

This example demonstrates the preparation of an indicator-carrying substrate, for use in a method or kit according to the invention.

The indicator used was 3′,3″,5′,5″-tetrabromophenolphthalein ethyl ester (Bromophthalein Magenta E, CAS No. 1176-74-5) (HTBPE). 100 mg of the indicator powder was dissolved in 100 g of a 1:1 mixture of HPLC-grade toluene and HPLC-grade isopropanol. This indicator solution is initially green in colour, and remains so when present in a neutral or acidic environment. In an alkaline environment, the indicator is magenta in colour in a typical gasoline fuel, and blue/green in a typical diesel fuel.

The indicator solution was applied to samples of different types of paper substrate, being (a) Whatman™ Grade 1 filter paper; (b) FisherBrand™ chromatography paper; (c) Lucas™ filter paper; (d) blotting paper; and (e) inkjet printer paper. Each substrate measured approximately 70×20 mm. The indicator was applied by dipping the papers in the indicator solution, following which the papers were dried in an oven to eradicate both the solvent mixture and ambient moisture, and then stored in a dessicator until ready for use. At this stage, the dried dye-carrying papers were off-white in colour.

The HTBPE solution would ordinarily be unstable, being both photosensitive and also prone to hydrolysis on contact with water. However, the test papers prepared in this example were found to remain stable in the dessicator, at ambient temperature, for up to seven days.

Alternatively, for inclusion in a test kit according to the invention, an indicator-carrying paper substrate could be stored in a protective atmosphere, for example in a sealed aluminium foil packet under nitrogen or argon. In this form, it could be stored and handled for relatively long periods of time without the stability issues usually associated with the use of indicator solutions, as in US-A-2008/0190354.

The paper samples (a) to (c) were deemed to be most suitable for use in the invention, as they discoloured less on application of the indicator solution. Of these, the chromatography paper (b) appeared to be the most effective, giving good indicator absorption with an even spread of the indicator solution. The blotting paper (d) tended to disintegrate following indicator application: the mass of the solution appeared to be too great for the paper weave to maintain its integrity.

### EXAMPLE 2

This example demonstrates the suitability of a method or kit according to the invention for determining the presence, and the approximate concentration, of an amine-based detergent additive in a diesel fuel.

The test fuel was a commercially available petroleum derived automotive gas oil (ex Shell). Samples of this fuel were blended with a commercially available detergent additive package, Nemo™ 2000, at treat rates of 1×, 2×, and 4× the standard treat rate (the standard treat rate, for Nemo™ 2000 in a maingrade fuel, being 250 mg/kg). Nemo™ 2000 contains a succinimide detergent active, which at the standard treat rate would be present in the fuel at 80 mg/kg.

A separate indicator-coated filter paper, prepared as in Example 1 using FisherBrand™ chromatography paper, was dipped briefly into each fuel sample, and also into the unadditivated fuel. The colours of the indicator papers were compared by eye.

The observed colour changes are summarised in Table 1 below.

TABLE 1

| | Colour observed |
|---|---|
| Indicator paper prior to use | White |
| Test fuel (unadditivated) | White/light yellow |
| Test fuel + 250 mg/kg additive | Light blue |
| Test fuel + 500 mg/kg additive | Mid-blue |
| Test fuel + 1,000 mg/kg additive | Dark blue |

These data show that the method of the invention may be used to detect the presence, and the approximate treat rate, of an amine-based detergent additive in a diesel fuel composition. The unadditivated fuel gives rise to a different indicator colour compared to that caused by the additivated fuels, whilst the additivated fuels give rise to an increasing depth of blue colour with increasing treat rate (ie increasing detergent concentration). An operator can use such results to determine whether a test fuel composition contains the detergent, and if so whether the detergent is present at its standard treat rate or (as in a so-called “premium grade” fuel) at a higher level. This in turn could be used for example for quality control, customer reassurance, product tracking or verification, fraud detection or many other commercial, technical or legal purposes.

Because the results take the form of colour changes, they can be readily assessed and interpreted by eye, without the need for complex, cumbersome or expensive analytical equipment. This makes the invented method particularly suitable for use away from the laboratory, by unskilled operators and often on relatively small fuel samples. A suitable test kit, for use in the field, is for instance described in Example 3 below.

To aid interpretation of the test results, it may be desirable to supply the operator with a reference colour chart, showing the colours observed on contacting the same indicator with fuels of known type and containing known concentrations (or concentrations within known ranges) of the additive being detected. For any given test sample, the operator then needs to compare the colour observed on contact with the indicator with the colours shown on the reference charts for a fuel having the same initial colour.

It is likely that colourless fuels will give rise to more vivid and intense colours, and to colours—at the various different detergent concentrations—that can more readily be distinguished from one another. The present invention may therefore be of particular use in testing such fuels, or compositions containing such fuels.

It is thought that the colourless fuels are less likely to interfere with or otherwise mask the colour of the indicator. It may also be the case that the low levels of aromatic, olefinic and heteroatom-containing species in Fischer-Tropsch derived gas oils, and/or their inherently low basicity, reduce the extent to which they can interfere with the chemistry of the test, compared for example to petroleum derived fuels.

Gasoline fuels will give rise to a different range of indicator colours, compared to those caused by diesel fuels. A typical gasoline fuel will turn the HTBPE indicator pink if it contains a detergent additive, with increasing additive concentrations causing increasing depth of the pink colour.

### EXAMPLE 3

### Field Test Kit

A test kit in accordance with the present invention, for use in conducting field tests on for example diesel fuels, comprises a substrate carrying an indicator dye such as HTBPE. The substrate is for example made from chromatography-grade filter paper. It is suitably packaged in a protective atmosphere, for example in an aluminium foil envelope or blister pack, filled with a dry inert gas such as nitrogen or argon. The foil is suitably impermeable to water, air and light.

The kit may contain two or more, separately packaged, indicator-carrying substrates, for use in two or more separate tests for example on two or more different test fuels.

The test kit suitably also contains a reference colour chart, which depicts the colours observed when the indicator is contacted with fuel compositions containing known concentrations (or concentrations within known ranges) of the relevant target species (for instance, of an amine-containing additive such as a detergent additive).

As described above, the colour charts may include colour ranges for two or more different types of fuel, for example for fuels having different initial colours; this allows the test results to be more readily interpreted, whatever the colour of the fuel composition being tested. They may also include a base fuel colour chart, showing the initial colours of a range of different fuel types; the user may then compare the colour of a fuel under test with those shown on the base fuel colour chart, and thereby select the most appropriate colour range chart from those supplied.

The colour charts may include colour ranges for two or more different target species, thus broadening the potential applications of the test.

It can be seen that such a test kit contains few essential components, and that those components can be easier and cheaper to produce, transport and use than those in conventional analytical systems, for instance the system described in US-A-2008/0190354 which requires fluid reagents.

A test kit according to the invention may also include instructions for carrying out a test. If desired, it may also include one or more of the following:

(a) one or more vessels, such as graduated glass tubes, in which to collect and analyse fuel samples;
(b) one or more pipettes for the transfer of fluid samples, for example to drop small amounts of a fuel sample onto the indicator paper;
(c) a solvent, for example n-heptane or n-hexane, with which to dilute a test fuel sample.

Of these, the diluting solvent may be particularly important, in particular when testing diesel fuel samples or for example lubricating oils which tend to contain relatively high concentrations of dispersant additives.

If an indicator is used which requires developing in order to generate a detectable spectroscopic response, then the test kit may include means for effecting such a development, for example a UV light to enable visualisation of a fluorescent indicator, or one or more additional reagents to add to a test sample in order to induce a suitable response in the indicator.

A test kit of the type described above may be used to conduct a simple field test to detect a detergent additive in a diesel or gasoline fuel, in accordance with the following instructions.

1. Tear open the foil package and remove the dye-carrying paper strip from inside it.
2. Dip the paper strip into the test fuel for the length of time recommended in the kit instructions, for example 1 to 3 seconds.
3. Observe any change in the colour of the dye on the paper strip.
4. Compare the colour of the test fuel with the base fuel colour chart, and thereby select the appropriate indicator colour reference chart from those provided.
5. Compare the observed colour of the paper strip, after it has been dipped into the test fuel, with those shown on the selected reference chart. This will provide the required indication of whether the detergent additive is present in the test fuel and if so, its approximate treat rate (concentration).

If appropriate, a sample of the test fuel may be poured into a suitable vessel, such as a clean glass tube, before dipping the indicator strip into the sample.

The test does not require a laboratory or specialist equipment. It can be carried out wherever necessary in the field. Ideally however, for health and safety reasons, it should be conducted in a well ventilated area. To facilitate assessment of the results, it may be preferred to conduct the test under subdued artificial lighting or shady conditions. It is suitably conducted at or around 20° C.

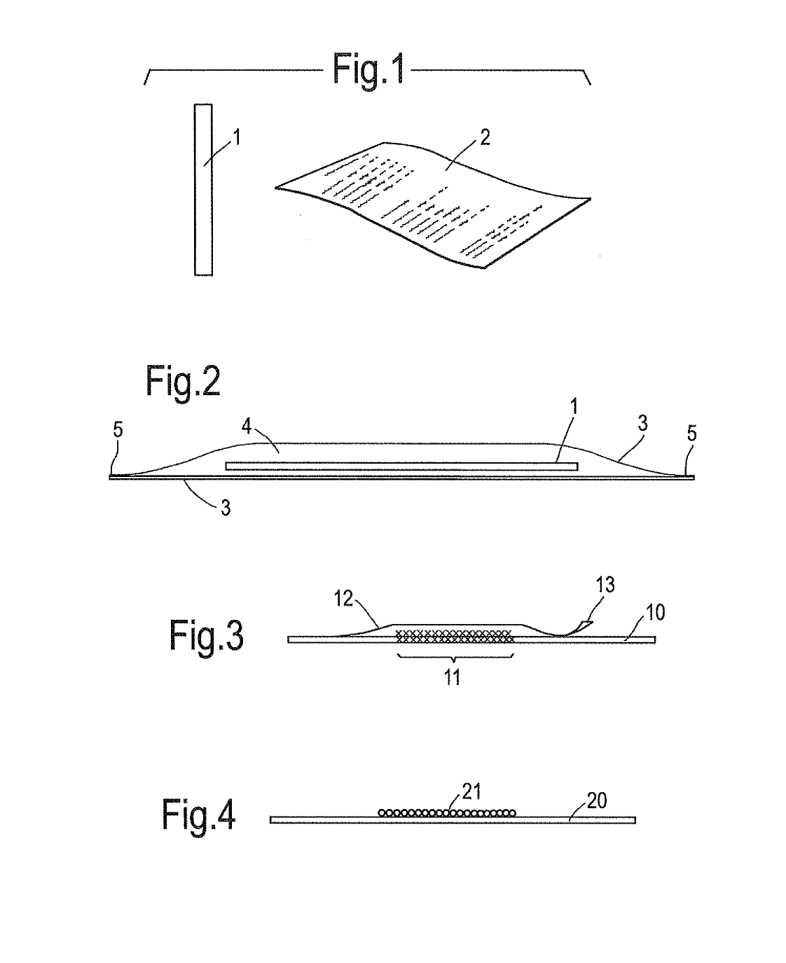

FIGS. 1 to 4 illustrate further embodiments of the test kit of the invention. The kit shown schematically in FIG. 1 comprises a strip of paper 1, for example of filter paper, which is impregnated with a suitable indicator (not visible in FIG. 1) such as HTBPE. The kit also comprises a reference sheet 2, which includes for example one or more colour charts to assist the user in interpreting the test results.

The paper strip 1 may be encapsulated in for example a blister pack or sealed envelope, as illustrated in FIG. 2. In FIG. 2, a protective material 3 such as a metal or plastics foil defines an enclosed chamber 4 in which the paper strip 1 is packaged prior to use. The chamber 4 suitably contains a dry, inert gas such as nitrogen. The material 3 is suitably impermeable to water, air and light. It may for example be heat sealed at its edges 5, and tearable to release the encapsulated paper strip.

Two or more paper strips 1 may be provided in the test kit, together with the reference sheet 2.

The paper strip 10 shown in FIG. 3 is also for use in a test kit according to the invention. It is impregnated with an indicator such as HTBPE in the region shown as 11. A layer 12 of a thin plastics film has been applied over the top of the region 11, to protect the indicator from moisture, air and ideally also light. The film layer 12 may be peeled away from the paper strip 10, by means of release tab 13, prior to use of the test strip in the invented method.

The paper strip 20 shown in FIG. 4, again for use in a test kit according to the invention, has been coated with a layer 21 of a microencapsulated indicator dye. The microencapsulating entities are designed so as to release the dye when the surface of the paper strip is rubbed. Prior to that point, however, they protect the encapsulated dye from environmental influences.

The paper strips shown in schematic cross section in FIGS. 2 to 4 are shown greatly enlarged compared to their likely actual dimensions.

1. A method for detecting a basic target species in a fuel composition comprising, (i) contacting the fuel composition with a solid substrate carrying a spectroscopically active indicator which is capable of reacting with the target species, and (ii) detecting the spectroscopic response of the indicator on or following its contact with the fuel composition.

2. The method of claim 1 wherein information about the concentration of the basic target species in the fuel composition is detected.

3. The method of claim 1 wherein the basic target species is a detergent or dispersant additive or a constituent thereof.

4. The method of claim 1 wherein the spectroscopically active indicator is capable of undergoing a colour change when contacted with the fuel composition.

5. The method of claim 4 wherein the indicator is a phenolphthalein indicator.

6. The method of claim 5 wherein the indicator is tetrabromophenolphthalein ethyl ester (HTBPE).

7. The method of claim 1 wherein the solid substrate is a paper substrate.

8. The method of claim 1 wherein the fuel composition is contacted with the indicator-carrying substrate by dipping the substrate, or at least a dye-carrying portion of the substrate, into the fuel composition, or by immersing the substrate or portion in the fuel composition, for an appropriate period of time.

9. The method of claim 1 wherein said substrate carries or is associated with a desiccant material.

10. The method of claim 1 wherein the fuel composition is a diesel fuel which has less than 10 ppmw sulphur content.

11. The method of claim 1 wherein a property of the fuel composition is signaled.

12. A test kit for use in detecting a basic target species in a fuel composition, the kit comprising a solid substrate carrying a spectroscopically active indicator which is capable of reacting with the target species in the fuel composition.

13. The test kit of claim 12 wherein the kit comprises a reference with which to compare the spectroscopic response of the indicator on or after being contacted with the fuel composition.

14. The test kit of claim 12, wherein the indicator-carrying solid substrate is packaged within a sealed chamber formed from a material which is impermeable to oxygen, water and/or light.

15. A method for preparing a fuel composition test kit or an essential component of said test kit, the method comprising loading a spectroscopically active indicator capable of reacting with the target species in the fuel composition onto a solid substrate.

16. The method of claim 15 wherein the indicator is loaded onto the solid substrate under an inert atmosphere.

17. The test kit of claim 13 wherein the reference is a color chart.
